(19) United States
(12) Patent Application Publication
(10) Pub. No.: US 2021/0192390 A1
(43) Pub. Date: Jun. 24, 2021

(54) DEVICE STATUS ASSESSMENT

(71) Applicant: Hewlett-Packard Development Company, L.P., Spring, TX (US)

(72) Inventors: Aravind Iyengar, Spring, TX (US); Gaurav Roy, Spring, TX (US); Madhurya Sarma, Pune (IN); Kevin Williams, San Diego, CA (US); Amit Kumar Singh, Spring, TX (US); Nileshkumar Gawali, Pune (IN); Sonal Jagdish Jambhule, Pune (IN); Chetan Satpute, Pune (IN)

(73) Assignee: Hewlett-Packard Development Company, L.P., Spring, TX (US)

(21) Appl. No.: 17/047,852

(22) PCT Filed: Sep. 24, 2018
(86) PCT No.: PCT/US2018/052446

§ 371 Date: Oct. 15, 2020

(51) Int. Cl. G06N 20/00; G06F 11/34

(52) U.S. Cl. CPC G06N 20/00; G06F 11/3495

(57) ABSTRACT

A system is provided including a memory in communication with a processor. The memory may store status data for a module of a device. The processor may generate a module score based on the status data, and generate a device score by applying a transformation to the module score. Moreover, the processor may assign the device to a status group based on the device score. The status group may include one of a healthy group and an unhealthy group. Furthermore, the processor may output the status group associated with an identifier of the device.

### BACKGROUND

Electrical devices may be used or deployed in large numbers. Such devices may have multiple components. Moreover, these devices may be used over extended periods of time.

### BRIEF DESCRIPTION OF THE DRAWINGS

FIG. 1 shows a flowchart of an example method that may be used to assess the status of a device.

FIG. 2 shows example data tables.

FIG. 3 shows further example data tables.

FIG. 4 shows a schematic representation of an example Device-as-a-Service ecosystem,

FIG. 5 shows a block diagram of an example computing system.

FIG. 6 shows a block diagram of an example computer-readable storage medium.

### DETAILED DESCRIPTION

Electrical devices degrade as they are used over time. Examples of such electrical devices include computing devices and other smart devices. Large numbers of such devices may be deployed within a Device-as-a-Service (DaaS) ecosystem. In a DaaS ecosystem a DaaS provider provides the use of devices, such as computing devices, to customers. The DaaS provider may retain responsibility for the devices, for example to remediate the devices by repairing or replacing them. In order to know which of the devices to remediate and at which time, a DaaS provider may assess the status of the devices; for example, to determine whether the devices are healthy.

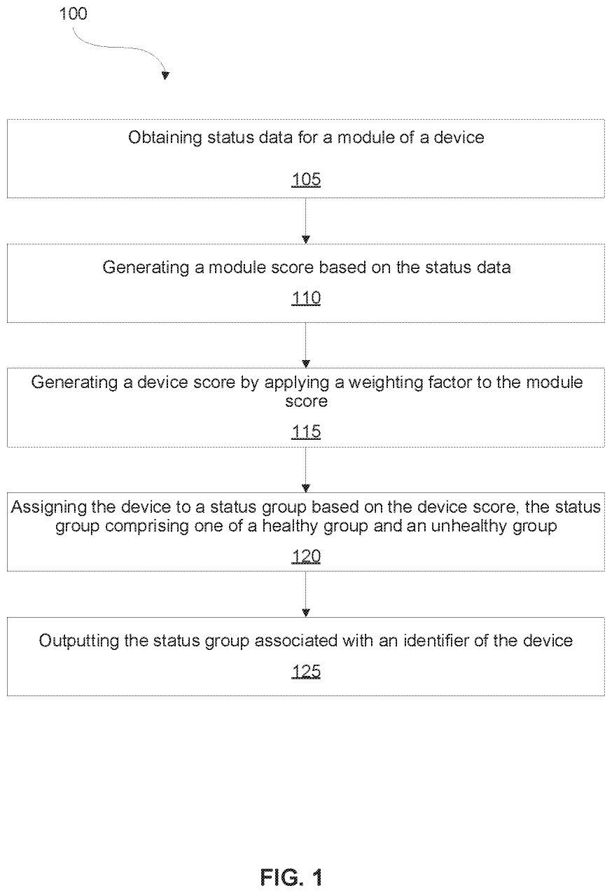

FIG. 1 shows a flowchart of an example method 100 that may be used to assess the status of a device. At box 105, status data may be obtained for a module of a device. In some examples the device may comprise an electrical device, such as a computing device, a smart device, and the like. The module may comprise an attribute, a functionality, or a physical component of the device. For example, when the device is a notebook computer, some example modules may include the battery, the processor, the storage disk, the operating system, and the like. Different devices may have different modules.

For a given device, the modules selected for monitoring may be those modules that have a relatively greater effect on the overall performance or health of the device. For example, for a notebook computer the status and performance of the operating system may have a greater effect on device health and performance than whether the camera is operational. Depending on the nature and the intended functionality of a given device, different modules may be considered as having a significant effect on the overall performance or health of the device.

The type of status data obtained may correspond to the module to which the status data relates. For example, for batteries status data may comprise actual or projected battery life, for storage disks status data may comprise the quantity of unused storage space, for processors the status data may comprise an operational temperature of the processor, and for operating systems the status data may comprise a count of the operating system crashes. Other appropriate types of status data may be used for these and/or other module types.

In some examples the set of the different types of status data monitored for a device may include central processing unit (CPU) grade, memory grade, battery grade, disk free space, disk errors, graphics grade, thermal grade, operating system crashes, software application errors, device boot time, software application launch times, and the like.

Such status data may be obtained in different ways depending on the module. Some modules may comprise onboard sensing or measuring capability, while other modules may be monitored by other modules of the device or by modules external to the device. For example, an operating system may be able to maintain a counter of its crashes, while a battery's battery life may be monitored by the CPU.

Moreover, the status data may be collected over time. This, in turn, may allow for monitoring the status of the module over time. In addition, historical status data collected over time may be used to monitor and condition the quality of the status data. For example, if historically battery life has been in the range of eight to six hours, and subsequently a new status data point is obtained showing six hundred hours as the battery life, the new status data point may be determined as being erroneous due to its large deviation from the historical record of battery life. Similarly, the historical status data record may be used to condition the status data by removing repeated or otherwise corrupted status data points.

Turning next to box 110 of method 100, a module score may be generated based on the status data. In some examples, the module score may comprise a numerical score. For example, the module score may range from one to five, with five representing the highest level status and one representing the lowest level status. Status may reflect a characterization of the device based on health, performance, or the like.

In some examples the module score may be generated by comparing the status data with other status data associated with other modules comparable to the module. Other comparable modules may be those modules that have similar physical or operational specifications to the module. In some examples, the physical or operational specifications being similar may refer to when the other modules are interchangeable with the module in the device without causing material changes to the specifications, capabilities, or performance of the device.

In some examples, other comparable modules may include those modules that have similar make and model as the module of the device. Moreover, in some examples other comparable modules may include those modules that have similar make, model, and configuration as the module of the device. Configuration may include the other components of the device with which the module cooperates, the typical use scenario of or load on the device, the age of the module or the device, and the like.

In examples where the module score is generated by comparison with comparable modules, the module score may be described as being relative to similar or comparable modules. Such a relative module score is different than an absolute performance benchmark intended to measure the performance of the module against the performance of the most capable and top-performing module available. For example, in order to obtain the relative module score for a medium-capacity battery that is three years old, the battery life of the medium-capacity battery may be compared to the battery life of other medium-capacity batteries that are also three years old, and not to the battery life of largest capacity batteries that are new.

A relative module score may in turn provide information about whether the module is underperforming or is unhealthy relative to comparable modules. This information may then be used to assess the status of the device containing the module, and determine whether remedial action is to be initiated.

In some examples, aggregate status data for other comparable modules may be used to generate the module score. For example, if the status data is in the top twenty percentile of the aggregate status data, then the module may be assigned a numerical module score of five to reflect a highest level of performance or health. If, on the other hand, the status data is in the bottom twenty percentile of the aggregate status data, then the module may be assigned a numerical module score of one to reflect a lowest level of performance or health. Similarly, the module may be assigned module scores of four, three, or two based on the percentile band of the aggregate status data in which the status data falls.

In an example of a DaaS ecosystem which deploys multiple devices having comparable modules, aggregate status data from these comparable modules may be used to generate the relative module score for a module of a given device. Moreover, in some examples an empirical performance or status model may be generated for the status or performance of comparable modules. For example, such a model my present the status or performance of the group of comparable modules as a function of age or extent of usage. Examples of such models may include machine learning models, statistical models, and the like. Such models may be based upon aggregate status data from devices within a given DaaS ecosystem, or aggregate status data from devices from multiple ecosystems, deployments, and the like.

Turning now to box 115 of method 100, a device score for the device may be generated based on the module score. In some examples the module score may be a numerical score ranging from five to one, with five representing the highest level of performance or health, and one representing the lowest level of performance or health.

In some examples, the device score may be generated by applying a transformation to the module score. Moreover, in some examples, the transformation may comprise a suitable function or operation applied to the module score. Furthermore, in some examples, the transformation may comprise applying a weighting factor to the module score. For example, the device score for a device with n modules may be calculated using the following equation:

$${\sum }_{i = 1}^{n} ( module {score}_{i} \times weighting {factor}_{i} ) \qquad ( Equation \text{-} 1 )$$

According to Equation-1, when n=1, the device score is a product of the module score multiplied by its corresponding weighting factor. When n>1, method 100 may include generating further module scores for further modules of the device. Generating the device score, in turn, may comprise calculating the sum of the module scores modified by their weighting factors. The weighting factors may act as multipliers to modify their corresponding module scores.

The device score calculated using Equation-1 may provide a single numerical score that takes into account relative module scores to provide a relative measure of the status such as performance or health of the device. As such, the device score may be used to rank or group multiple devices, for example in a DaaS ecosystem, into status groups such as healthy or unhealthy groups. This, in turn, may allow for a determination of whether a given device is a candidate for remediation, and if so, to initiate the remediation process.

The weighting factors for the module scores may be selected to reflect the effect or the contribution of a given module score on the overall performance or health of the device. In examples where a one-to-five scale is used for the device score, the weighting factors may also be chosen to produce a device score in the one-to-five range.

In some examples, the weighting factors may be generated using a machine learning model. A machine learning model may include a deep learning model. Example machine learning models may include a Deep Feed Forrest, and the like. In such an example, a training dataset may be provided for training the machine learning model. The training dataset may include training device scores associated with corresponding training module scores. In some examples the training device scores may be manually generated. In other words, given the training module scores for a given device, the given device may then be manually scored based on the training module scores to determine the associated training device score. Moreover, in some examples, the training device scores may be empirically generated using historical data of actual device health or performance outcomes.

Using Equation-1 as an example, the weighting factors may be generated using a machine learning model using the following example method: the weighting factors may initially be set to be equal to one another. For example, if Equation-1 is to take into account n module scores, then each weighting factor may initially be set to 1/n. Then Equation-1 is used to calculate the device score, which is then compared to the training device score. If the calculated device score has a deviation from the training device score that is greater than an accuracy threshold, then the weighting factors are altered and the device score is recalculated.

The process of altering weighting factors and recalculating the device score may be repeated until the deviation of the calculated device score from the training device score is within the accuracy threshold. The set of weighting factors that allow the calculated device score to meet the accuracy threshold may then be retained and used for calculation of device scores beyond the training phase. The manner in which the weighting factors are altered from one iteration to another may be determined by the machine learning model used.

Mile the method of generating the weighting factors is described in the context of Equation-1 as an example, it is contemplated that a similar method may be used to obtain weighting factors or other characteristics or constants for other equations for calculating the device score. In examples where the training dataset is in the context of or associated with a given device type, a machine learning model trained on such a training dataset may produce weighting factors that are also associated with or specific to that given device type. Moreover, in some examples, the training dataset may comprise historical data of performance or failure of devices, or a combination of historical and current, live data of the performance or failure of devices.

In some examples, the equation for calculating the device score may further indicate that if a module score is below a threshold, then the device score is set to a predetermined value. In the example where the module scores and device scores are on the one-to-five scale, the equation for calculating the device score may indicate that if a module score is one, then the device score will also be set to one. This may reflect the assessment that if the status, performance, or health of a module is at the lowest level, then the device may also be vulnerable or unstable due to its unhealthy module. As such, the device score may also be set to one to reflect this vulnerability or instability of the device.

Moreover, in some examples the generated device score may be compared with a historical device score to determine a deviation of the device score from the historical device score. In some examples, the historical device score may comprise one score such as the preceding device score in a time series of device scores. In other examples, the historical device score may comprise an aggregate device score, such as a mean or median device score, an all-time average of device scores, a moving average of several preceding device scores, and the like.

If the deviation of the device score from the historical device score exceeds a threshold, then the device score may be designated as invalid. This may help to normalize the device scores to filter out as invalid device scores that deviate too greatly from the historical or expected device scores. While this type of device score normalization may be used in some examples, in other examples un-normalized device scores may be retained to reflect unexpected or rapid-onset degradations in device status, health, or performance. Such unexpected or rapid-onset degradations may for example be caused by mechanical failures, malware infections, and the like.

Turning now to box 120 of method 100, the device may be assigned to a status group based on the device score. In some examples, the status group may comprise one of a healthy group and an unhealthy group. In the example where the device score is measured on the one-to-five scale, a device with the device score of one may be assigned to the unhealthy group, while a device with a device score in the range of two to five may be assigned to the healthy group.

In some examples, a device may be assigned to a status group by associating an identifier of the device with the status group. For example, the identifier of the device may be stored in a column of a data table, the column being associated with the status group. In some examples, the identifier of the device may include a serial number, a device nickname, or the like.

Moreover, in some examples the status group may be different than healthy and unhealthy groups. Examples of such status groups may include performance-based status groups, and the like. For examples, a device with a device score of five may be placed in a high-performance group, and another device with a device score of four may be placed in a relatively lower performance group.

Furthermore, in some examples the device may be assigned to the unhealthy group if one module score is below a given threshold. In other words, a device having a module with a module score below the threshold may be assigned to the unhealthy status group even if the device score by itself does not indicate that the device is to be assigned to the unhealthy group.

For example, when module scores are determined on the one-to-five scale, the threshold may be set at being below two. In this example, if a device has a module that has a module score of 1 and a device score of 3, the device may be assigned to the unhealthy group because the module score of its module is below the threshold, i.e. below two. In some examples, when a module score is below the threshold, a device score may not be generated since the device may be assigned to the unhealthy status group without basing the status group assignment on the device score.

Turning now to box 125 of method 100, the status group, associated with the identifier of the device, may be output. To output the status group and the associated identifier, the status group and the identifier may be stored in a memory, sent to an output terminal, communicated to another component or to another system, or the like. In some examples, the identifier of the device may be presented in a column of a status group table, which column may be associated with a status group such as healthy or unhealthy.

Moreover, in some examples the identifier of the device and the status group may be presented graphically, to allow for visual determination of whether the device has been assigned to the healthy or unhealthy group. In some examples, the device score may be output in association with the identifier of the device. The device score may be output in addition to or instead of the status group.

Furthermore, in some examples remediation of the device may be initiated if it is determined that the device has been assigned to the unhealthy group. Remediation may comprise repairing or replacing the device or some or all of the modules of the device. The status data may be communicated to a remediator, which may then initiate the remediation processor.

The remediator may comprise a system or a device. For example, if the unhealthy status group is a result of too many operating systems crashes, the remediator may comprise a computing system that debugs or reinstalls the operating system on the device. In some examples, the remediator may comprise an operator. If, for example, the device has been assigned to the unhealthy group due to having a battery with a very short battery life, then upon receiving the status group designation of the device, the operator may physically replace the battery of the device. In some examples, the remediator may comprise a hybrid or a combination of a system and an operator.

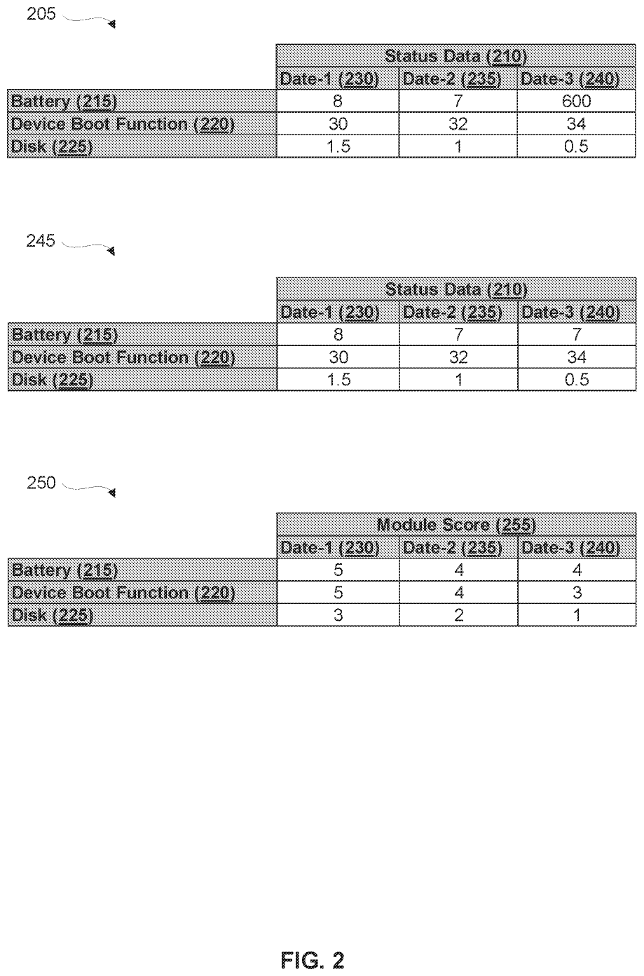

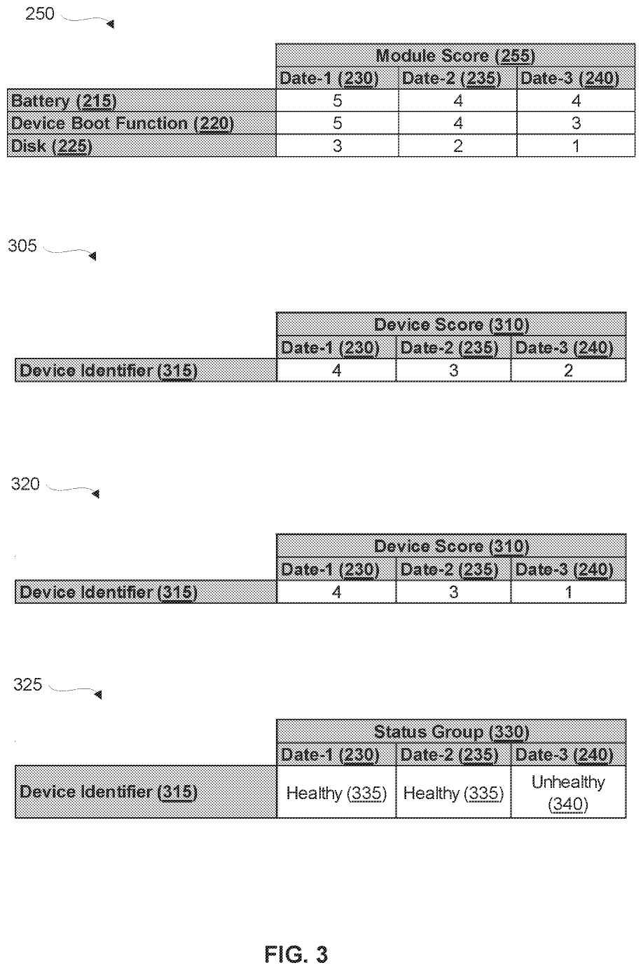

Turning now to FIGS. 2 and 3, example data tables are shown to illustrate an example operation of method 100 and the other methods described herein. FIGS. 2 and 3 are illustrative examples, and method 100 and the other methods described herein are not limited to the examples shown in FIGS. 2 and 3.

FIG. 2 shows an example data table 205, which summarizes status data 210 related to three modules over three time points. The three modules are battery 215 whose status data comprises battery life measured in hours, device boot function 220 whose status data comprises device boot time measured in seconds, and disk 225 whose status data comprises disk free space measured in gigabytes. The three time points are date-1 230, date-2 235, and date-3 240. The three dates may also represent different times that may be on the same date.

FIG. 2 shows another example data table 245 that is similar to table 205, with the exception of the status data 210 for battery 215 on date-3 (240). Table 205 shows battery life of battery 215 as being eight hours on date-1, seven hours on date-2, and six hundred hours on date-3. There is a high probability that six hundred hours is an erroneous battery life status data as it deviates greatly from the eight and seven hours of battery life on date-1 and date-2.

The statue data in table 245 may be obtained by conditioning status data 210 in table 205. For example, the erroneous six hundred hours of battery life may be deleted and replaced by a different value. In some examples, last-observation-carried-forward imputation may be used whereby last acceptable, observed value of battery life, i.e. the seven hours on date-2, is carried forward and imputed to the battery life on date-3. As such, the battery life on date-3 may also be indicated as seven hours in the table 245 of conditioned status data.

FIG. 2 also shows another example data table 250, which summarizes module scores 255 for the three modules of battery 215, device boot function 220, and disk 225 over the three dates of date-1 230, date-2 235, and date-3 240. Module scores 255 may comprise values on the one-to-five scale with five representing the highest or best status or performance and one representing the lowest or worst status or performance. As discussed above, the module scores 255 may be generated on a relative basis and using comparison with status data of other comparable modules.

FIG. 3 shows table 250, and also example data table 305. Table 305 summarizes device scores 310 for a device having the three modules 215, 220, and 225, with device scores 310 shown over the three dates of date-1 230, date-2 235, and date-3 240. The device may have a device identifier 315. The device scores 310 may also be presented on a one-to-five scale. The device score of four on date-1 may be generated by plugging into Equation-1 or into another similar equation the module scores 255 associated with date-1 from table 250. The weighting factors used in the equation may have been generated using a machine learning model trained on a training dataset, as described above. Device scores 310 for date-2 235 and date-3 240 may be generated in a similar manner, and based on module scores 255 from date-2 and date-3 columns of table 250 respectively.

FIG. 3 also shows example data table 320, which is similar to table 305, with the exception that the device score 310 value on date-3 240 is changed from two in table 305 to one in table 320. In some examples, this change may be made to device score 310 based on module scores 255 from table 250. Because module score 255 for disk 225 is one, the lowest level, on date-3 240, device score 310 on date-3 240 may also be adjusted to one, the lowest value. As discussed earlier, this type of adjustment may represent the assessment that a device having a module with the module score below a given threshold may be vulnerable or unstable. As such, device score 310 may be set to be also below a threshold, in this example to the lowest value one, to reflect the device's vulnerability or instability due to having a module with a low module score.

Furthermore, FIG. 3 shows example data table 325, which summarizes status groups 330 for the device at date-1 230, date-2 235, and date-3 240. In table 325, device identifier 315 is associated with status group healthy 335 on date-1 230 and date-2 235, and with status group unhealthy 340 on date-3 240. The status group 330 may be determined based on device score 310 from table 320. In some examples, a device with a device score of two or higher may be assigned to a healthy status group, as shown for date-1 230 and date-2 235 in table 325. A device with a device score below 2 may be assigned to an unhealthy status group, as shown for date-3 240 in table 325.

While table 250 shows three rows listing three modules, it is contemplated that in other examples table 250 may comprise fewer or more rows listing different, fewer, or more modules. Moreover, while table 325 shows one row listing device identifier 315, it is contemplated that in other examples table 325 may comprise multiple rows listing identifiers for multiple devices. These, for example, may be devices that are part of a DaaS ecosystem. Furthermore, in other examples the data tables may have status data, module scores, and device scores for fewer or greater than the three dates shown in the tables of FIGS. 2 and 3.

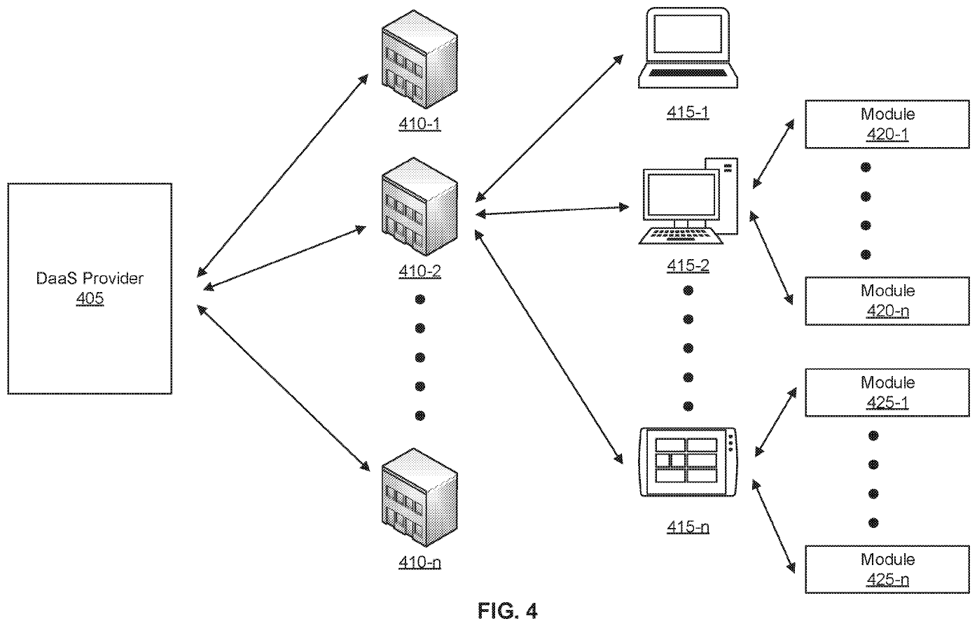

Turning now to FIG. 4, a schematic representation is shown of an example DaaS ecosystem comprising a DaaS provider 405, which serves customers 410-1, 410-2 to 410-n, collectively referred to as customers 410.

The DaaS provider 405 may provide to a customer a number of devices 415-1, 415-2 to 415-n, collectively referred to as devices 415. While devices are shown in FIG. 4 only for customer 410-2, the other customers may also be provided with devices. Moreover, while devices 415 are shown as being connected to DaaS provider 405 through customer 410-2, it is contemplated that devices 415 may be in direct communication with DaaS provider 405.

A device may have a number of associated modules. For example, device 415-2 may have modules 420-1 to 420-n, collectively referred to as modules 420. Similarly, device 415-n may have modules 425-1 to 425-n, collectively referred to as modules 425. Mile not shown in FIG. 4, other devices such as device 415-1 may also have modules.

Status data related to these modules may be used to generate module scores, which in turn may be used to generate device scores. The device scores, in turn, may be used to assign the devices in the DaaS ecosystem to a status group. The device scores and the status groups may allow an operator or remediator of the DaaS ecosystem to quantify the status or performance of the devices 415, and to determine which of the devices 415 to prioritize for remediation. For example, the devices with the lowest device scores or devices assigned to the unhealthy status group may be prioritized for remediation.

Method 100 and the other methods described herein may allow for generation of the device score, which may comprise one number that summarizes status data for multiple device modules. In the case of ecosystems with a large number of devices having multiple modules whose status data is collected for many data collection time points over long time periods, the data sets related to the status of the ecosystem devices may become large and complex. The device scores described herein may summarize this voluminous status information, which in turn may allow this status information, in the form of device scores, to be stored, retrieved, manipulated, or output using less memory and less processing power.

In addition, as the module scores may be generated in a manner relative to comparable modules, the module scores and in turn the device scores may be used to determine the health of a device and to decide when the device is to be remediated. Furthermore, as machine learning models may be used to generate or derive the equation for calculating the device scores, e.g. by determining the weighting factors in Equation-1, method 100 and the other methods described herein may reduce the need for devices to be scored manually.

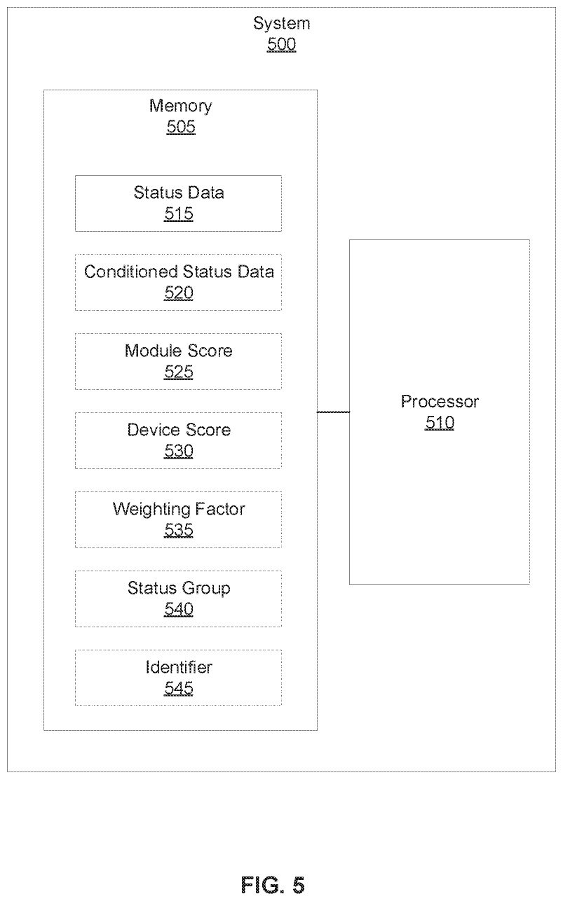

Turning now to FIG. 5, a system 500 is shown which may be used to assess the status of a device. System 500 comprises a memory 505 in communication with a processor 510. Processor 510 may include a central processing unit (CPU), a graphics processing unit (GPU), a microcontroller, a microprocessor, a processing core, a field-programmable gate array (FPGA), or similar device capable of executing instructions. Processor 510 may cooperate with the memory 505 to execute instructions.

Memory 505 may include a non-transitory machine-readable storage medium that may be an electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. The machine-readable storage medium may be encoded with executable instructions. In some example systems, memory 505 may include a database.

Memory 505 may store status data 515 for a module of a device. In some examples processor 510 may condition status data 515 to generate conditioned status data 520. To condition status data 515, processor 510 may, for example, remove out-of-range or redundant data points from status data 515. In addition, processor 510 may generate a module score 525 based on status data 515. In examples where status data 515 is conditioned to form conditioned status data 520, module score 525 may be generated based on conditioned status data 520.

Furthermore, processor 510 may generate a device score 530 based on module score 525. For example, device score 530 may be generated by applying a transformation to module score 525. In some examples, device score 530 may be generated by applying a weighting factor 535 to module score 525. For example, processor 510 may generate device score 530 by plugging module score 525 and weighting factor 535 into Equation-1.

Moreover, processor 510 may assign the device to a status group 540 based on device score 530. In some examples, memory 505 may store a status group identifier of status group 540. Furthermore, in some examples, status group 540 may comprise one of a healthy group and an unhealthy group. Processor 510 may also output status group 540 associated with an identifier 545 of the device.

In FIG. 5, conditioned status data 520, module score 525, device score 530, weighting factor 535, status group 540, and identifier 545 are shown in dashed lines to signify that while this information may be stored in memory 505 of system 500, in some examples some or all of the information may be stored outside system 500 or outside memory 505 in system 500. Furthermore, in some examples, status data 515 may not be stored in memory 505, and may be stored outside system 500 or outside memory 505 in system 500.

In some examples processor 510 may generate module score 525 by comparing status data 515 with other status data associated with other modules comparable to the module whose module score is being generated. In examples where processor 510 conditions status data 515 to form conditioned status data 520, conditioned status data 520 may be compared with other status data associated with other modules comparable to the module whose module score is being generated.

In addition, in some examples processor 510 may also generate a further module score for a further module of the device. To generate device score 530, processor 510 may then sum module score 525 modified by weighting factor 535 and the further module score modified by a corresponding further weighting factor. In some examples, processor 510 may use Equation-1, with n set to be greater than one, to calculate the sum.

To generate weighting factor 535, in some examples processor 510 may use a machine learning model trained on a dataset comprising training device scores associated with corresponding training module scores. In some examples, weighting factor 535 may be generated by a processor other than processor 510 or by a system other than system 500.

Moreover, in some examples processor 510 may determine whether module score 525 is below a threshold. Processor 510 may then assign the device to an unhealthy group if module score 525 is below the threshold.

The features and functionality described in relation to system 500 may be similar to the corresponding features and functionality described in relation to method 100 and the other methods described herein. Furthermore, the example systems described herein may perform method 100 and the other methods and functions described herein, for example in relation to FIGS. 1-3. The example systems may also be used in the context of a DaaS ecosystem, for example as shown in FIG. 4.

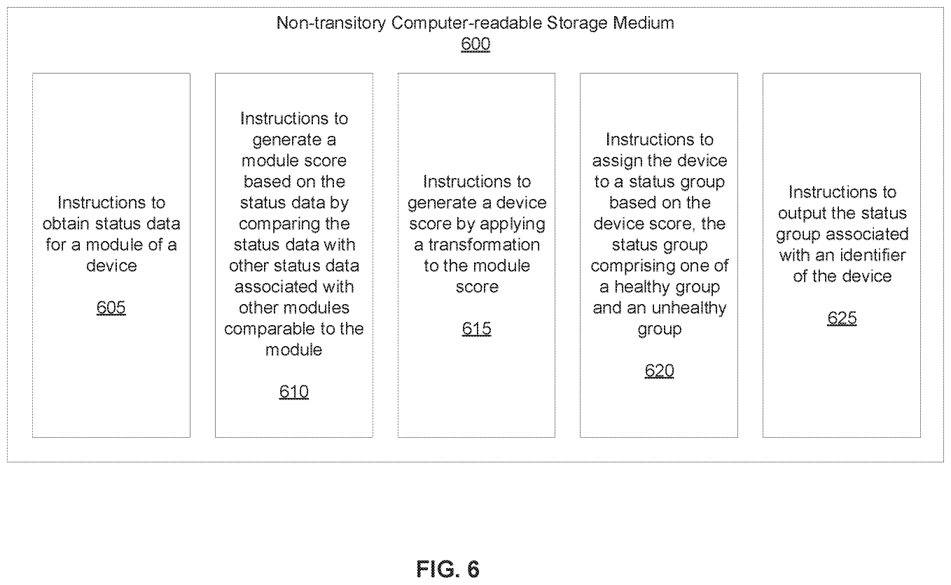

Turning now to FIG. 6, a non-transitory computer-readable storage medium (CRSM) 600 is shown, which comprises instructions executable by a processor. The CRSM may comprise an electronic, magnetic, optical, or other physical storage device that stores executable instructions. The instructions may comprise instructions 605 to cause the processor to obtain status data for a module of a device. The instructions may also comprise instructions 610 to cause the processor to generate a module score based on the status data. In some examples the module score may be generated by comparing the status data with other status data associated with other modules comparable to the module whose module score is being generated.

Moreover, the instructions may also comprise instructions 615 to cause the processor to generate a device score by applying a transformation to the module score. In some examples, the transformation may comprise applying a weighting factor to the module score. For example, the processor may generate the device score by plugging the module score and the weighting factor into Equation-1.

The instructions may also comprise instructions 620 to cause the processor to assign the device to a status group based on the device score. In some examples the status group may comprise one of a healthy group and an unhealthy group. Furthermore, the instructions may also comprise instructions 625 to cause the processor to output the status group associated with an identifier of the device.

In some examples, the instructions may further comprise instructions to cause the processor to generate a further module score for a further module of the device. To generate the device score the instructions may then cause the processor to sum the module score modified by the weighting factor and the further module score modified by a corresponding further weighting factor. In some examples, the processor may use Equation-1, with n set to be greater than one, to calculate the sum.

In addition, in some examples the instructions may further cause the processor to generate the weighting factor using a machine learning model. The machine learning model may have been trained on a dataset comprising training device scores associated with corresponding training module scores.

Moreover, in some examples the instructions may further cause the processor to determine whether the module score is below a threshold. The instructions may also cause the processor to assign the device to the unhealthy group if the module score is below the threshold.

The features and functionality described in relation to CRSM 600 may be similar to the corresponding features and functionality described in relation to method 100 and the other methods and systems described herein. Furthermore, the example CRSMs described herein may also comprise instructions to cause a processor and/or system to perform the methods described herein, to perform the functions demonstrated in FIGS. 1-3, and to be used in the context of a DaaS ecosystem, for example as shown in FIG. 4.

Moreover, the methods, systems, and CRSMs described herein may include the features and/or perform the functions described herein in association with one or a combination of the other methods, systems, and CRSMs described herein.

The methods, systems, and CRSMs described herein may allow for generating one numerical device score to summarize and reflect status data of multiple modules of a device, Such a device score may reduce the amount of memory and computational power used to store, retrieve, manipulate, and analyze the information on the status and health of a device.

For device ecosystems, such as a DaaS ecosystem, with a large number of devices whose module status data may be collected in a time-series over long periods of time, the volume of the status data may be correspondingly large. The ability of device scores described herein to summarize the status information into one numerical device score for a given device on a given date may produce correspondingly large savings in memory and computational power.

Moreover, as machine learning models may be used to derive the equation for calculating the device scores, e.g. by determining the weighting factors in Equation-1, the methods, systems, and CRSMs described herein may reduce the need for devices to be scored manually. Manual scoring of a large number of devices may be time-consuming and prone to errors or inconsistency. The errors and inconsistencies may arise due to factors such as subjective variability between scorers, the variability of a given scorer over time, and the like. The use of the methods, systems, and CRSMs described herein, including the use of machine learning in the device scoring process, may make the scoring process and the scores themselves more objective and consistent.

In addition, as the module score may be relative and generated in comparison to comparable modules, the device score, generated based on those relative module scores, may provide an indication of the status and health of the device. This indication of health or status may in turn be used to determine whether a device is to be remediated. Furthermore, numerical device scores may be easily sorted and categorized, which may facilitate reviewing and analyzing the status and health of the devices. This in turn may facilitate the ability of a remediator to determine which devices are to be remediated and to prioritize the remediation process.

It should be recognized that features and aspects of the various examples provided above may be combined into further examples that also fall within the scope of the present disclosure.

1. A method comprising:
obtaining status data for a module of a device;
generating a module score based on the status data;
generating a device score by applying a weighting factor to the module score;
assigning the device to a status group based on the device score, the status group comprising one of a healthy group and an unhealthy group; and
outputting the status group associated with an identifier of the device.

2. The method of claim 1, further comprising:
generating a further module score for a further module of the device; and
wherein generating the device score comprises calculating a sum of the module score modified by the weighting factor and the further module score modified by a corresponding further weighting factor.

3. The method of claim 1, further comprising generating the weighting factor using a machine learning model trained on a dataset comprising training device scores associated with corresponding training module scores.

4. The method of claim 1, further comprising:
determining whether the status group comprises the unhealthy group; and
if the status group comprises the unhealthy group, initiating remediation of the device.

5. The method of claim 1, further comprising:
comparing the device score with a historical device score to determine a deviation of the device score from the historical device score; and
designating the device score as invalid if the deviation exceeds a threshold deviation.

6. A system comprising:
a memory to store status data for a module of a device;
a processor in communication with the memory, the processor to:
condition the status data;
generate a module score based on the status data;
generate a device score by applying a weighting factor to the module score;
assign the device to a status group based on the device score, the status group comprising one of a healthy group and an unhealthy group; and
output the status group associated with an identifier of the device.

7. The system of claim 6, wherein the processor is to generate the module score by comparing the status data with other status data associated with other modules comparable to the module.

8. The system of claim 6, wherein:
the processor is further to generate a further module score for a further module of the device; and
to generate the device score the processor is to sum the module score modified by the weighting factor and the further module score modified by a corresponding further weighting factor.

9. The system of claim 6, wherein the processor is further to generate the weighting factor using a machine learning model trained on a dataset comprising training device scores associated with corresponding training module scores.

10. The system of claim 6, wherein the processor is further to:
determine whether the module score is below a threshold; and
wherein the processor is to assign the device to the unhealthy group if the module score is below the threshold.

11. A non-transitory computer-readable storage medium comprising instructions executable by a processor, the instructions to cause the processor to:
obtain status data for a module of a device;
generate a module score based on the status data by comparing the status data with other status data associated with other modules comparable to the module;
generate a device score by applying a transformation to the module score;
assign the device to a status group based on the device score, the status group comprising one of a healthy group and an unhealthy group; and
output the status group associated with an identifier of the device.

12. The non-transitory computer-readable storage medium of claim 11, wherein the transformation comprises applying a weighting factor to the module score.

13. The non-transitory computer-readable storage medium of claim 12,
wherein the instructions are further to cause the processor to generate a further module score for a further module of the device; and
wherein to generate the device score the instructions are to cause the processor to sum the module score modified by the weighting factor and the further module score modified by a corresponding further weighting factor.

14. The non-transitory computer-readable storage medium of claim 12, wherein the instructions are to further cause the processor to generate the weighting factor using a machine learning model trained on a dataset comprising training device scores associated with corresponding training module scores.

15. The non-transitory computer-readable storage medium of claim 11, wherein the instructions are further to cause the processor to:
determine whether the module score is below a threshold; and
wherein the instructions are to cause the processor to assign the device to the unhealthy group if the module score is below the threshold.
